(19) United States
(12) Patent Application Publication
(10) Pub. No.: US 2004/0199639 A1
(43) Pub. Date: Oct. 7, 2004

(54) Automated shared drive mapping

(76) Inventor: Mitchell N. Harris, Berkley, MI (US)

Correspondence Address: BAKER BOTTS L.L.P., 2001 ROSS AVENUE, 6TH FLOOR, DALLAS, TX, 75201, US

(21) Appl. No.: 10/407,834

(22) Filed: Apr. 4, 2003

(51) Int. Cl. G06F 15/16

(52) U.S. Cl. 709/227

(57) ABSTRACT

One aspect of the invention is a method for mapping shared areas in an enterprise network that includes retrieving user information identifying one or more shared areas to which a user has access in the enterprise network. User input identifying at least a selected one of the one or more shared areas with which the user desires to link is received. A command is generated to cause an operating system to map the selected one of the shared areas to the user's login-id.

### TECHNICAL FIELD OF THE INVENTION

This invention relates generally to network operating systems and more particularly to an automated network drive mapping system and method.

### BACKGROUND OF THE INVENTION

Employees and associates of an enterprise may have share permissions to access different servers or areas within an enterprise network. For example, a single user may have access to or be given permissions to a personal area of the network and to one or more shared areas of the network. Typically, there are two types of permissions that may be associated with a user's login-id. Share permissions grant rights to the user allowing or denying access to one or more shared areas or groups of shared areas. Examples of shared permissions may include, but are not limited to, “Read,” “Change,” and “Full Control.” Share permissions may be granted to the user by manipulating settings associated with the user's login-id that are stored in the network operating system. Areas that are available to all employees are unrestricted or “wide open.” For example, wide open areas may include employee handbooks, logos, templates, and forms. Other areas may be available to only a particular employee or to groups of employees. These areas may include applications, enterprise data, and/or personal data. The share permission granting a user the right to access a particular area applies to all files and folders within the shared resource. Share permissions, however, apply only to users who gain access to the resource over the network and do not apply to users who gain access to the shared resource at the computer where the resource is stored.

To provide share permissions to each permitted area in some operating systems, a user may be mapped to a network drive or drives. The mapping may be performed using a login script initiated when a user logs in to the network. For an enterprise utilizing a Microsoft Windows operating system, secondary shared areas to which the user has access often are manually mapped by the user or for the user. Such a system sometimes requires employees to have knowledge of the steps necessary to perform the mapping. Alternatively, network administrators may program a login script to accomplish the mapping. However, an employee's share permissions within an enterprise network frequently change, as does the organization of the network. These changes, along with personnel changes, may impose a high burden on information technology staff of large organizations due to the frequency of login script adjustments.

The second type of permissions are file system or operating system permissions. File system or operating system permissions determine what the user may do with the files or applications to which the user has share permissions to access. Examples of file system or operating system permissions may include, but are not limited to, “Full Control,” “Modify,” “Read & Execute,” “List Folder Contents,” “Read,” and “Write.” Each file system or operating system permission includes a subset of additional special permissions that operate at the file or folder level to delineate what the user may do with the file or folder.

### SUMMARY OF THE INVENTION

One aspect of the invention is a method for mapping shared areas in an enterprise network that includes retrieving user information identifying one or more shared areas to which a user has access in the enterprise network. User input identifying at least a selected one of the one or more shared areas with which the user desires to link is received. A command is generated to cause an operating system to map the selected one of the shared areas to the user's login-id.

The invention has several important technical advantages. Various embodiments of the invention may have none, one, some, or all of these advantages without departing from the scope of the invention. The invention allows for the creation of a custom script for an individual user. The custom script may include customized mappings associating the user with particular areas to which the user has access and may include assignment of a network drive identifier as selected by the user. The invention may allow for automated mapping of a user's drive preferences each time the user logs in to the enterprise network. Because the user can create the custom mapping, a script may be customized to the user's specific preferences. Because a tool allows a user to create a mapping script, system administrators may be relieved of the burden of continually updating login scripts each time the user's share permissions or job functions change.

### BRIEF DESCRIPTION OF THE DRAWINGS

For a more complete understanding of the present invention and the advantages thereof, reference is now made to the following descriptions taken in conjunction with the accompanying drawings in which:

FIG. 1 illustrates a block diagram of a general purpose computer that may be used in accordance with the present invention;

FIG. 2 illustrates a block diagram of an example enterprise network that may be used in accordance with the present invention;

FIG. 3 illustrates an example mapping tool made in accordance with one aspect of the present invention; and

FIG. 4 illustrates a flow chart describing an example of the mapping of one or more shared areas in an enterprise network to a user in accordance with the present invention.

### DETAILED DESCRIPTION OF THE INVENTION

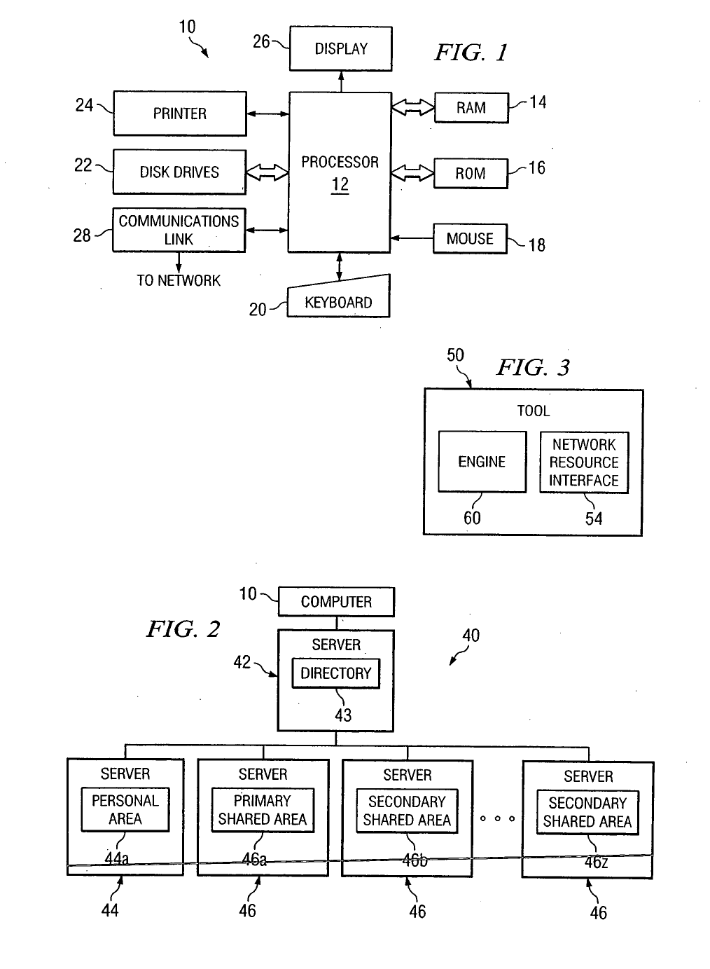

The preferred embodiment of the present invention and its advantages are best understood by referring to FIGS. 1-4 of the drawings, like numerals being used for like and corresponding parts of the various drawings.

FIG. 1 illustrates a general purpose computer 10 that may be used for the automated mapping of network drives in an enterprise network in accordance with the present invention. Specifically, general purpose computer 10 may comprise a portion of an enterprise network and may be used to execute applications and software to access various components of the enterprise network. General purpose computer 10 may be adapted to execute any of the well known MS-DOS, PC-DOS, OS2, UNIX, MAC-OS and Windows operating systems or other operating system. The invention may be particularly useful in a Windows based client server network. As used throughout this document, operating system may refer to the local operating system for computer 10, a network operating system, or a combination of both. In some embodiments, the network operating system and the local computer operating system may act in concert to accomplish the mapping of shared areas to the user's login-id. General purpose computer 10 comprises processor 12, random access memory (RAM) 14, read only memory (ROM) 16, mouse 18, keyboard 20, and input/output devices such as printer 24, disk drives 22, display 26 and communications link 28. The present invention includes programs that may be stored in RAM 14, ROM 16, or disk drives 22 and may be executed by processor 12. Communications link 28 is connected to a computer network but could be connected to a telephone line, an antenna, a gateway, or any other type of communication link. Disk drive 22 may include a variety of types of storage media such as, for example, floppy-disk drives, hard disk drives, CD ROM drives, or magnetic tape drives. Disk drive 22 may also include-a network disk housed in a server within the enterprise network. Although this embodiment employs a plurality of disk drives 22, a single disk drive 22 could be used without departing from the scope of the invention. FIG. 1 only provides one example of a computer that may be used with the invention. The invention could be used with computers other than general purpose computers as well as general purpose computers without conventional operating systems.

FIG. 2 illustrates an example enterprise network 40 that may be used in the automated mapping of network drives in accordance with the present invention. Enterprise network 40 comprises computer 10, directory server 42, a personal data server 44, and one or more shared data servers 46. The network 40 may have more or less servers of these or differing types without departing from the scope of the invention. While directory server 42, personal data server 44, and shared data servers 46 are illustrated as separate servers, some or all of the functions of these servers could be combined. That is, some or all of a directory 43, a personal area 44a, a primary shared area 46a, and any secondary shared areas 46b-z could reside on the same server. Computer 10 may be substantially as described with regard to FIG. 1 or may comprise any other general purpose computer. While only one computer 10 is illustrated, it is understood that network 40 will typically have multiple users, each with a computer 10.

Computer 10 communicates with directory server 42 to dynamically manage and access attributes and share permissions within enterprise network 40 that are particular to a user. Share permissions may be a collection of rights that delineate those portions of enterprise network 40 to which a user has access (or optionally does not have access or both). In particular examples, directory 43 may comprise a Lightweight Directory Access Protocol (LDAP) directory based on the X.500 standard. More specifically, directory 43 may comprise an active directory within the Microsoft Windows operating system.

For the management of user preferences and share permissions, directory 43 may include values and objects associated with a user of enterprise network 40. Objects associated with a user may include printers, email addresses, files, data sources, applications, peripheral devices such as printers, and identifications of specific areas of enterprise network 40. For example, objects in directory 43 that are associated with, a user may identify an area on one or more shared data servers 46 and one or more personal data servers 44 to which a particular user has access. Where, for example, directory 43 is an active directory for a Windows operating system, directory 43 may call a login script upon the successful login of a user to computer 10. The login script may include attributes that allow a primary shared area 46a to be mapped to a user using a particular network drive identifier. Additionally, the login script may allow a personal or home area 44a to be mapped to the user using a different network drive identifier. In Windows, drive identifiers are typically letters but any type of drive identifier could be used in connection with the invention.

Areas of network servers or entire network servers may be associated with drive identifiers. Such identifiers may sometimes vary for each user. That is, two different users may at times use a different drive identifier to refer to the same physical shared area 46a-z. In one example, the default attributes may include mapping primary shared area 46a to the G: drive identifier and mapping personal area 44a to the H: drive identifier. Because these mappings may be included in the login script, these mappings may be automatically made each time a user successfully logs in to enterprise network 40. Because the Windows active directory is currently limited to a few default attributes for network mapping, only a very few drives may be automatically mapped for a single user upon login using the mapping functions supplied by the network. Any secondary shared areas 46b-z to which the user has access may be manually mapped by the user after each successful login. Alternatively, enterprise system administrators may manage custom login scripts for mapping shared areas 46a to the user's login-id.

Users may need to know the steps necessary to map secondary shared areas 46b-z when using the current version of Windows. Additionally, users may need to know what network drive identifiers are appropriate for each particular secondary shared area 46b-z. For example, some secondary shared areas 46b-z may be required to be mapped to a particular drive identifier. Manual mapping by users may be time-consuming and may lead to a decrease in the productivity or enterprise users. Alternatively, enterprise system administrators may write additional scripts to be executed upon login to perform drive mapping. Such scripts allow for the automatic mapping of one or more secondary shared areas 46b-z upon login. Network based scripts, however, may place additional loads on the enterprise network and may require additional time for processing. Thus, administrator mapping may also be complicated and time-consuming in a large enterprise. Continual updates may be needed as the user's share permissions or roles change within enterprise network 40.

In accordance with the invention, a tool is provided to map secondary shared areas 46b-z to a user's login-id. The tool may cause mapping to occur or be used to generate a custom mapping script particular to a user to be executed on login. Of course, any type of commands that will accomplish mapping are acceptable and a script need not be used. FIG. 3 illustrates an example mapping tool 50 for performing automated mapping of shared areas in an enterprise network 40. Tool 50 may comprise an application stored in directory server 42 or other enterprise server. Tool 50 may be stored or executed on multiple servers or on one or more processors within a server. Tool 50 may also be stored on the user computer 10, in whole or in part, and executed, in whole or in part, on one or more processors of computer 10. Where, for example, tool 50 is stored on computer 10, computer 10 may also include any applications or programs for implementing tool 50. Tool 50 may include a network resource interface 54 and an engine 60. Tool 50 may automatically initiate commands when a user logs into enterprise network 40 at computer 10 or another general computer. Alternatively, engine 60 could be activated by the user.

Network resource interface 54 may comprise an interface between tool 50 and other network resources. For example, network resource interface 54 may allow tool 50 to receive information and communications from computer 10 and other general computers in enterprise network 40. Additionally, network resource interface 54 may allow engine 60 to communicate with and receive information from various servers and databases in enterprise network 40 to achieve mapping of shared areas 46a-z to a user's login-id.

Tool 50 may comprise any engine, server, or other software which may accomplish the mapping of shared areas 46a-z to the user's login-id. Tool 50 may be operable to receive user information, identify share permissions associated with the user, and identify mandatory drive designations associated with particular shared areas 46a-z. Additionally, tool 50 may operate to receive user selections. For example, tool 50 may receive drive designations selected by the user and determine whether the user desires automated mapping or manual mapping.

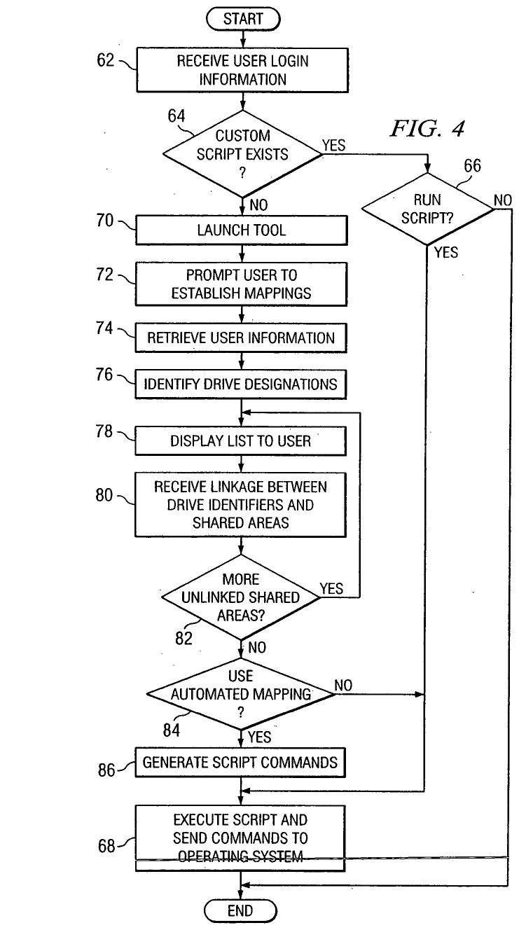

In operation, tool 50 may be activated upon login and/or manually activated by the user. The invention is not restricted to any mode of activation. Engine 60 may retrieve user information identifying shared areas 46a-z to which a user has access. Such information may be retrieved from directory server 42 or any other server or database in or accessible to computer 10 or directory 43. As will be described in further detail with regard to FIG. 4, engine 60 may also retrieve mandatory drive designations identifying particular shared areas 46a-z that are required to have the same drive identifier when used by some or all users within one or more groups.

To affect the mapping of the shared areas 46a-z identified by tool 50, tool 50 may display a list of accessible shared areas 46a-z to the user and receive user drive designations from the user. In some embodiments, the list of shared areas may be displayed to the user using a user interface. Accordingly, drive designations may be received from the user through a web page or other graphical user interface using the network resource interface 54 to communicate with computer 10. In particular embodiments, the list may be displayed on computer 10 through an Intranet, extranet, Internet, or other network available to the enterprise network. Although an Intranet, externet, or Internet interface may provide a simple and effective mechanism for displaying a list of shared areas 46a-z to the user and for receiving mappings for the shared areas 46a-z, it is appreciated that any other interface, program, or application may be used to receive mappings from the user. Engine 60 may then cause mapping to occur by generating commands to link the shared areas 46a-z to the user's login-id with the user selected drive identifiers. Embodiments of the invention may include (a) the ability to generate commands to the operating system to accomplish mapping, (b) the ability to generate a custom script (or other set of commands) to accomplish mapping, or (c) both. Where a custom script is created for a user, engine 60 of tool 50 may allow for the automated mapping of shared areas 46a-z to the user's login-id upon successive logins. Upon successive logins, computer 10 may execute an application or program to determine whether a custom script exists on computer 10 and execute such a script where it is found. Alternatively, tool 50 can be used each time upon login. While the illustrated embodiment maps secondary shared areas 46b-z, it could also be used to map primary shared areas.

FIG. 4 illustrates a flow chart describing an example mapping of one or more shared areas 46a-z in an enterprise network 40 in accordance with the present invention. The automated mapping described herein may be carried out using computer software, as can any or all of the processes described below. That software may be executed by directory server 42, by general purpose computer 10, any other computer or a combination of computers.

In step 62, the enterprise network 40 receives user login information. The user login information may include a login-id, password, and/or any other information identifying the particular user to enterprise network 40. The login information may be used to authenticate the user by determining the user's right to access enterprise network 40. After the user is authenticated, the enterprise network operating system may determine whether a custom script exists for the particular user at step 64. For example, where tool 50 is stored on the computer at which the user has successfully logged in, the computer may determine whether a custom script is stored on the computer or in a server to which the user has access within the enterprise network 40. Thus, an application or program may be executed on computer 10 to determine whether a custom script specific to the user is stored on computer 10.

If a custom script exists, computer 10 may question the user to determine whether the user desires to run the custom script at step 66. To make this determination, computer 10, engine 60, or the operating system of enterprise network 40 may query the user to ask if the user wants to have the custom mapping executed. As will be described in detail with regard to step 80, the custom mapping may identify user-selected drive designations associated with one or more shared areas 46a-z to which the user has access. If the user chooses to run the script, engine 60 of tool 50 may generate commands to the operating system at step 68 after which the method may terminate. Although step 66 is described as querying the user, it is acknowledged that in some embodiments step 66 may be omitted. In such an embodiment, if computer 10 determines that a custom script exists at step 64, tool 50 may automatically execute the custom script.

Returning to step 64, if the computer 10 determines that a custom script does not exist on computer 10 or a server, tool 50 is launched at step 70. In step 74, the user may be prompted by any method to establish desired mappings. Such prompt may be displayed to the user as a pop-up window, a message, or any other mechanism for communicating to the user through computer 10. In response to the prompt, the user may initiate a mapping session. The prompt may direct the user as to how to initiate the mapping session. Alternatively, the user may have previous knowledge as to how to initiate the mapping session. Although a prompt may be used to direct the user to initiate the mapping session, it is acknowledged that step 74 may be omitted. Thus, the mapping session may be automatically be initiated by engine 60. Once the mapping session is initiated, engine 60 may provide a user interface for receiving user information and mappings. The user interface may include a web page or other graphical user interface displayed to the user over an intranet, an extranet, the Internet, or another network.

In step 74, engine 60 receives user information. The user information may identify the user to the tool. In some embodiments, engine 60 may inherently recognize user credentials from the user's login information. Alternatively, engine 60 may trigger another authentication process to verify the user's identity for added security. Additionally, the user information may include the identification of one or more shared areas 46a-z to which the user has access and a description of the shared areas 46a-z. Such information may be received from directory 43 or from any server or database in enterprise network 40. Alternatively, the user information may identify share permissions or characteristics associated with the user, and engine 60 may use the same to identify one or more shared areas 46a-z that the user has permission to access.

In step 76, engine 60 identifies drive designations from computer 10, directory 43, or any other server or database in the enterprise network 40. The drive designations may include possible drive identifiers that may be associated by the user to each shared area 46a-z. The drive designations may also include any preferred or mandatory drive designations that the user should or must associate with particular shared areas 46a-z. Although preferred and mandatory drive designations may be retrieved from the same data storage location that stores user information, the two types of information need not be stored in the same physical location. Similarly, the information need not be stored in a data storage location in the same physical location as directory 43 or tool 50. While mandatory drive designations may be used with the invention, it is not necessary to do so.

A mandatory drive designation may identify a specific shared area 46a-z to which a particular drive identifier must be associated as required by enterprise network 40, a customer, system architecture, the particular application, or the particular program. For example, enterprise applications may make reference to a particular shared area 46a-z using a specific, or mandatory, drive identifier. Where a mandatory drive designation is associated with a specific shared area 46a-z, engine 60 may not allow the user to override the mandatory drive mapping required by enterprise network 40. Thus, these shared areas 46a-z may not be customizably mapped to the user's login-id. Rather, engine 60 may automatically assign the drive identifier to the particular shared area 46a-z. The user may, however, still be able to choose whether or not to map to the shared area with the mandatory drive designation. This is true of all shared areas as the invention does not (but could) require the user to map to all areas he has share permissions to map to.

At step 78, engine 60 may cause a user interface to list one or more shared areas 46a-z to which the user has share permissions to access. As previously described, the list may be displayed to the user over a web page or other graphical user interface. The list may include a description of each shared area 46a-z and a list of drive identifiers that may be associated by the user to each shared area 46a-z. Engine 60 may provide a way for the user to associate or assign a drive identifier to some or all of the shared areas 46a-z. Additionally, the list may provide a way for the user to indicate whether or not he desires a shared area to be mapped. This could be an indicator such as, for example, a box to check or could occur automatically upon the choice of a drive identifier. Any shared areas 46a-z which have been identified by engine 60 as having an associated mandatory drive identifier may not be listed and could be automatically included for mapping. Alternatively, such shared areas 46a-z may be listed to the user, but engine 60 may restrict the user to associating the mandatory drive identifier with the particular shared area 46a-z.

At step 80, engine 60 may receive and store data indicating a linkage between the drive identifier or identifiers selected by the user, the shared areas 46a-z, and the user. For example, the linkage may include drive designations indicating the user's desire to associate the R: drive with a first secondary shared area 46b and the S: drive with a second secondary shared area 46c. In the above example, engine 60 may store data creating a linkage between the R: drive, first secondary shared area 46b, and the user. In some embodiments, engine 60 may automatically assign all drive identifiers automatically.

At step 82, engine 60 may determine whether any additional unlinked shared areas 46a-z are accessible to the particular user. Thus, engine 60 may determine whether any shared areas 46a-z listed to the user in step 78 remain unlinked to a user-selected drive identifier. If one or more unlinked shared areas 46a-z exist, engine 60 may receive further drive designations from the user at step 80 and create additional links between the selected drive identifiers, the shared areas 46a-z, and the user until all or substantially all shared areas 46a-z to which the user has access have been mapped to the user's login-id. Alternatively, the user could indicate that he has finished creating linkages and does not desire to link any remaining unlinked shared areas 46a-z.

When the user indicates that there are no additional designations to make or, optionally, when engine 60 determines that there are no additional designations to make, engine 60 may determine whether the user wishes to use automated mapping at step 84. If the user does not desire automated mapping upon login, engine 60 may generate commands to the operating system to accomplish the mapping in step 86. After this step, the user may be linked with shared areas 46a-z according to his designations without the need to re-login. In some embodiments, this step could be omitted and the user could be forced to re-login to link to shared areas using a script (or other set of commands) generated by tool 50. Upon subsequent logins to the enterprise network 40, the particular user may be required to repeat steps 70 through 86 to accomplish the mapping of shared areas 46a-z unless a script (or other set of commands) is generated by engine 60.

Conversely, if at step 84 the engine determines that the user desires automated mapping to occur upon login, engine 60 may generate a script (or another set of commands) to accomplish the mapping upon subsequent logins. The script may be stored on computer 10 or any server or data storage location in enterprise network 40 to which the user has access. The script may be written as a custom script file or as any other set of commands for mapping shared areas 46a-z to the user's login-id. Because the script may be stored to the enterprise network 40, the script may be automatically executed upon subsequent logins by the user to enterprise network 40, as will be understood by those of ordinary skill in the art. To accomplish the mapping for the user's current session with the enterprise network 40, engine 60 may generate commands to the operating system at step 86. Following such mapping the method may terminate. Just as was noted above, step 86 could be omitted without departing from the scope of the invention.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, applicants wish to note that they do not intend any of the appended claims to invoke ¶ 6 of 35 U.S.C. § 112 as it exists on the date of filing hereof unless “means for” or “step for” are used in the particular claim.

What is claimed is:

1. A method for mapping shared areas in an enterprise network, comprising:
retrieving user information identifying one or more shared areas to which a user has access in the enterprise network;
receiving user input identifying at least a selected one of the one or more shared areas with which the user desires to link; and
generating a command operable to cause an operating system to map the selected one of the shared areas to the user's login-id.

2. The method of claim 1, further comprising:
sending the command to the operating system to accomplish the mapping of the selected one of the shared areas to the user's login-id.

3. The method of claim 1, further comprising:
storing the command in a script file.

4. The method of claim 1, further comprising:
sending the command to the operating system to accomplish the mapping of the selected one of the shared areas to the user's login-id; and
storing the command in a script file.

5. The method of claim 1, further comprising:
retrieving a mandatory drive designation, the mandatory drive designation identifying a particular shared area in the enterprise network and a mandatory drive identifier associated with the particular shared area; and
generating a command operable to cause an operating system to map particular shared area to the user's login-id using the mandatory drive identifier.

6. The method of claim 1, further comprising:
receiving a user selection identifying a drive identifier; and
generating a command operable to cause the operating system to link the selected one of the shared areas to the user's login-id using the drive identifier.

7. The method of claim 1, further comprising:
retrieving a mandatory drive designation, the mandatory drive designation identifying a particular shared area in the enterprise network and a mandatory drive identifier associated with the particular shared area;
receiving a user selection identifying a drive identifier;
generating a command operable to cause an operating system to map particular shared area to the user's login-id using the mandatory drive identifier; and
generating a command operable to cause the operating system to link the selected one of the shared areas to the user's login-id using the drive identifier.

8. The method of claim 1, wherein generating a command operable to cause the operating system to map the selected one of the shared areas to the user's login-id occurs automatically after the user logs in to the enterprise network.

9. A tool for mapping shared areas in an enterprise network, comprising a readable storage medium; a tool stored on the readable storage medium and operable to:
retrieve user information identifying one or more shared areas to which a user has access in the enterprise network;
receive user input identifying at least a selected one of the one or more shared areas with which the user desires to link; and
generate a command operable to cause an operating system to map the selected one of the shared areas to the user's login-id.

10. The tool of claim 9, further operable to:
send the command to the operating system to accomplish the mapping of the selected one of the shared areas to the user's login-id.

11. The tool of claim 9, further operable to:
store the command in a script file.

12. The tool of claim 9, further operable to:
send the command to the operating system to accomplish the mapping of the selected one of the shared areas to the user's login-id; and
store the command in a script file.

13. The tool of claim 9, further operable to:
retrieve a mandatory drive designation, the mandatory drive designation identifying a particular shared area in the enterprise network and a mandatory drive identifier associated with the particular shared area; and
generate a command operable to cause an operating system to map particular shared area to the user's login-id using the mandatory drive identifier.

14. The tool of claim 9, further operable to:
receive a user selection identifying a drive identifier; and
generate a command operable to cause the operating system to link the selected one of the shared areas to the user's login-id using the drive identifier.

15. The tool of claim 9, further operable to:
retrieve a mandatory drive designation, the mandatory drive designation identifying a particular shared area in the enterprise network and a mandatory drive identifier associated with the particular shared area;
receive a user selection identifying a drive identifier;
generate a command operable to cause an operating system to map particular shared area to the user's login-id using the mandatory drive identifier; and
generate a command operable to cause the operating system to link the selected one of the shared areas to the user's login-id using the drive identifier.

16. The tool of claim 9, further operable to generate a command to cause the operating system to map the selected one of the shared areas to the user's login-id automatically after the user logs in to the enterprise network.

17. The tool of claim 9, wherein the tool is further operable to receive user input identifying at least a selected one of the one or more shared areas through a web interface.

18. A script stored on a computer-readable storage medium, the script generated by:
retrieving user information identifying one or more shared areas to which a user has access in the enterprise network;
receiving user input identifying at least a selected one of the one or more shared areas with which the user desires to link; and
generating a command operable to cause an operating system to map the selected one of the shared areas to the user's login-id.

19. The script of claim 18, further generated by:
retrieving a mandatory drive designation, the mandatory drive designation identifying a particular shared area in the enterprise network and a mandatory drive identifier associated with the particular shared area; and
generating a command operable to cause an operating system to map particular shared area to the user's login-id using the mandatory drive identifier.

20. The script of claim 18, further generated by:
receiving a user selection identifying a drive identifier; and
generating a command operable to cause the operating system to link the selected one of the shared areas to the user's login-id using the drive identifier.
